(19) United States
(12) Patent Application Publication
(10) Pub. No.: US 2014/0359746 A1
(43) Pub. Date: Dec. 4, 2014

(54) AUTHENTICATION SYSTEM, AUTHENTICATION SERVER, AUTHENTICATION METHOD, AND AUTHENTICATION PROGRAM

(71) Applicants: Yukiko Tezuka, Minato-ku (JP); Kazuki Kato, Minato-ku (JP)

(72) Inventors: Yukiko Tezuka, Minato-ku (JP); Kazuki Kato, Minato-ku (JP)

(21) Appl. No.: 14/345,582

(22) PCT Filed: Aug. 14, 2012
(86) PCT No.: PCT/JP2012/005149

§ 371 Date: Mar. 18, 2014

(30) Foreign Application Priority Data
Sep. 20, 2011 (JP) 2011-204438

(51) Int. Cl. H04L 29/06

(52) U.S. Cl. CPC H04L 63/0853
USPC 726/9

(57) ABSTRACT

A validity judgment means 81 judges validity of each received service ID. A service availability judgment means 82 judges availability of a service utilizing a medium or device identified by a physical ID based on the received physical ID. An authentication information management means 84 stores at least a service ID and a judgment result of the service ID by the validity judgment means 81 in an authentication information storage means 83 in association with a key ID. A use right judgment means 85 judges a use right of a service to be utilized by the user from a service ID and a judgment result of the service ID in association with a key ID stored in the authentication information storage means 83 based on a policy defining a service available range depending on at least a combination of service IDs.

### TECHNICAL FIELD

The present invention relates to an authentication system for authenticating a user utilizing a service, an authentication server, an authentication method and an authentication program.

### BACKGROUND ART

In recent years, there is known cloud computing as one form in which a user can ubiquitously utilize a computer resource such as service or storage provided via Internet.

With the cloud computing, the latest technique such as virtualization technique or data distribution technique is used to combine many groups of servers, thereby providing various services. On the other hand, many items of data are intensively managed in the cloud computing, and thus a more robust mechanism for protecting the data is desired.

When a user utilizes many services provided by use of the cloud computing, there is typically employed a method in which a service authenticates a user and only an authenticated user is permitted to access. For example, when a user utilizing a service inputs ID and password via an Internet browser or the like, the service authenticates the ID and password and determines availability of the service.

There is known a method in which an IC card incorporating an IC chip storing user identification information therein is read by a card reader thereby to authenticate a user. There is known a method for reading an IC card and requesting a password in order to secure that the user of the IC card is authorized.

PLT 1 describes an exemplary authentication system therein. In the authentication system described in PLT 1, a user terminal includes an IC card reader, and a storage device for storing therein an IC reading program for controlling the IC card reader and reading the user ID of the IC card. When a portal server providing a service transmits a command of activating the ID reading program to the user terminal, the user terminal acquires the user ID from the IC card reader and transmits the acquired user ID to the portal server. The portal server authenticates the user based on the user ID transmitted from the user terminal. With the authentication system described in PLT 1, an authentication screen in which the user ID is displayed and user authentication information is input is displayed, and a password is input therein.

### CITATION LIST

### Patent Literature

PLT 1: JP 2008-97205 A

### SUMMARY OF INVENTION

### Technical Problem

A service via cloud computing can be advantageously used from various places, but can be illegally accessed from anywhere once information necessary for authentication is leaked. There is a problem that such illegal access causes leakage of the information on the cloud.

A user ID to be input in the web browser or the like is easily distributed to a user, but is so easily leaked. That is, persons other than the user identified by the ID can use the ID. Therefore, there is a possibility that a person acquires the ID and easily impersonates the user identified by the ID.

A password used for authentication is also information which is likely to be leaked and which can be estimated based on user attribute or the like. Thus, if the password is acquired by a person other than the user, the person impersonates the user and can illegally use a service.

On the other hand, the authentication method using a physical medium such as IC card is very effective in enhancing its security since authentication cannot be made without the medium. That is, so-called software information such as ID or password is easily acquired by other person, while a physical object such as IC card is difficult to acquire by other person.

However, it can be assumed that an IC card is acquired by other person due to theft or loss. In this case, for example, the ID inside the IC card is read by a card reader or the like which is not permitted to use, and personal authentication is illegally made and the illegal person impersonates the authorized user and can access a service on the cloud.

As in the authentication system described in PLT 1, illegal access by an illegal person can be avoided in combination of personal authentication by the IC card and an input password. As described above, however, the password is also easily acquired, and thus a combination of the IC card and the password cannot sufficiently keep security. Thus, there is desired high-level authentication control including not only user's personal authentication but also user's actually-using environment.

Various services are provided on the cloud computing. An authentication level required in each service is typically different and thus it is desirable that a method for authenticating each service can be dynamically changed.

It is therefore an exemplary object of the present invention to provide an authentication system capable of dynamically performing high-level authentication control depending on an environment in which a user utilizes a service, an authentication server, an authentication method and an authentication program.

### Solution to Problem

An authentication system according to the present invention is characterized by including an authentication server for authenticating a user utilizing a service and an authentication request terminal for making a service authentication request to the authentication server, wherein the authentication request terminal includes an identification information transmission means for transmitting a physical ID as identification information capable of uniquely identifying a medium or device used for authenticating a user utilizing a service, and a service ID as identification information defined per type of the medium or device to the authentication server, the authentication server include a validity judgment means for judging validity of each received service ID, a service availability judgment means for judging availability of a service utilizing a medium or device identified by a physical ID based on the received physical ID, an authentication information management means for, when it is judged that a service utilizing the medium or device is available, storing at least a service ID and a judgment result of the service ID by the validity judgment means in association with a key ID in an authentication information storage means with a combination of one or more service IDs capable of identifying one authentication request made by the user among received service IDs as the key ID, and a use right judgment means for judging a use right of a service to be utilized by the user from a service ID and a judgment result of the service ID in association with a key ID stored in the authentication information storage means based on a policy defining a service available range depending on at least the combination of service IDs, and the identification information transmission means in the authentication request terminal transmits a physical ID of a previously-defined medium or device among one or more mediums or devices used for authentication, and one or more previously-defined service IDs in the medium or device used for authentication to the authentication server.

An authentication server according to the present invention is characterized by including a validity judgment means for judging validity of each service ID when receiving a physical ID as identification information capable of uniquely identifying a medium or device used for authenticating a user utilizing a service and a service ID as identification information defined per type of the medium or device from an authentication request terminal for making an authentication request for the service, a service availability judgment means for judging availability of a service utilizing a medium or device identified by a physical ID based on the received physical ID, an authentication information management means for, when it is judged that a service utilizing the medium or device is available, storing at least a service ID and a judgment result of the service ID by the validity judgment means in an authentication information storage means in association with a key ID with a combination of one or more service IDs capable of identifying one authentication request made by the user among received service IDs as the key ID, and a use right judgment means for judging a use right of a service to be utilized by the user from a service ID and a judgment result of the service ID in association with a key ID stored in the authentication information storage means based on a policy defining a service available range depending on at least the combination of service IDs.

An authentication method according to the present invention is characterized in that an authentication request terminal for making a service authentication request to an authentication server for authenticating a user utilizing a service transmits, to the authentication server, a physical ID as identification information capable of uniquely identifying a medium or device used for authenticating a user utilizing the service and a service ID as identification information defined per type of the medium or device, the authentication server judges validity of each received service ID, the authentication server judges availability of a service utilizing a medium or device identified by a physical ID based on the received physical ID, when judging that a service utilizing the medium or device is available, the authentication server stores at least a service ID and a validity judgment result of the service ID in an authentication information storage means in association with a key ID with a combination of one or more service IDs capable of identifying one authentication request made by the user among received service IDs as the key ID, the authentication server judges a use right of a service to be utilized by the user from a service ID and a judgment result of the service ID in association with a key ID stored in the authentication information storage means based on a policy defining a service available range depending on at least the combination of service IDs, and when transmitting the physical ID and the service ID, the authentication request terminal transmits, to the authentication server, a physical ID of a previously-defined medium or device among one or more mediums or devices used for authentication, and one or more previously-defined service IDs in the medium or device used for authentication.

An authentication program according to the present invention is characterized by causing a computer to perform a validity judgment processing of judging validity of each service ID when receiving a physical ID as identification information capable of uniquely identifying a medium or device used for authenticating a user utilizing a service and a service ID as identification information defined per type of the medium or device from an authentication request terminal for making an authentication request for the service, a service availability judgment processing of judging availability of a service utilizing a medium or device identified by a physical ID based on the received physical ID, an authentication information management processing of, when it is judged that a service utilizing the medium or device is available, storing at least a service ID and a validity judgment result of the service ID in an authentication information storage means in association with a key ID with a combination of one or more service IDs capable of identifying one authentication request made by the user among the received service IDs as the key ID, and a use right judgment processing of judging a use right of a service to be utilized by the user from a service ID and a judgment result of the service ID in association with a key ID stored in the authentication information storage means based on a policy defining a service available range depending on at least the combination of service IDs.

### Advantageous Effects of Invention

According to the present invention, it is possible to dynamically perform high-level authentication control depending on an environment in which a user utilizes a service.

### BRIEF DESCRIPTION OF DRAWINGS

FIG. 1 It depicts a block diagram illustrating an exemplary structure of a first exemplary embodiment of an authentication system according to the present invention.

FIG. 2 It depicts an explanatory diagram illustrating an exemplary flow of data.

FIG. 3 It depicts an explanatory diagram illustrating other exemplary flow of data.

FIG. 4 It depicts a sequence diagram illustrating exemplary authentication processings of the authentication system according to the first exemplary embodiment.

FIG. 5 It depicts a sequence diagram illustrating other exemplary authentication processings of the authentication system according to the first exemplary embodiment.

FIG. 6 It depicts a sequence diagram illustrating still another exemplary authentication processings of the authentication system according to the first exemplary embodiment.

FIG. 7 It depicts a block diagram illustrating an exemplary structure of a second exemplary embodiment of the authentication system according to the present invention.

FIG. 8 It depicts an explanatory diagram illustrating an exemplary cloud system to which the authentication system according to the present invention is applied.

FIG. 9 It depicts a sequence diagram illustrating exemplary operations of the authentication system when a user utilizes a DaaS service.

FIG. 10 It depicts a sequence diagram illustrating exemplary operations of the authentication system when a user utilizes a printing service.

FIG. 11 It depicts an explanatory diagram illustrating exemplary operations of transmitting information from a terminal to an ID authentication layer.

FIG. 12 It depicts a block diagram illustrating an exemplary minimum structure of the authentication system according to the present invention.

FIG. 13 It depicts a block diagram illustrating an exemplary minimum structure of an authentication server according to the present invention.

### DESCRIPTION OF EMBODIMENTS

Exemplary embodiments according to the present invention will be described below with reference to the drawings.

### First Exemplary Embodiment

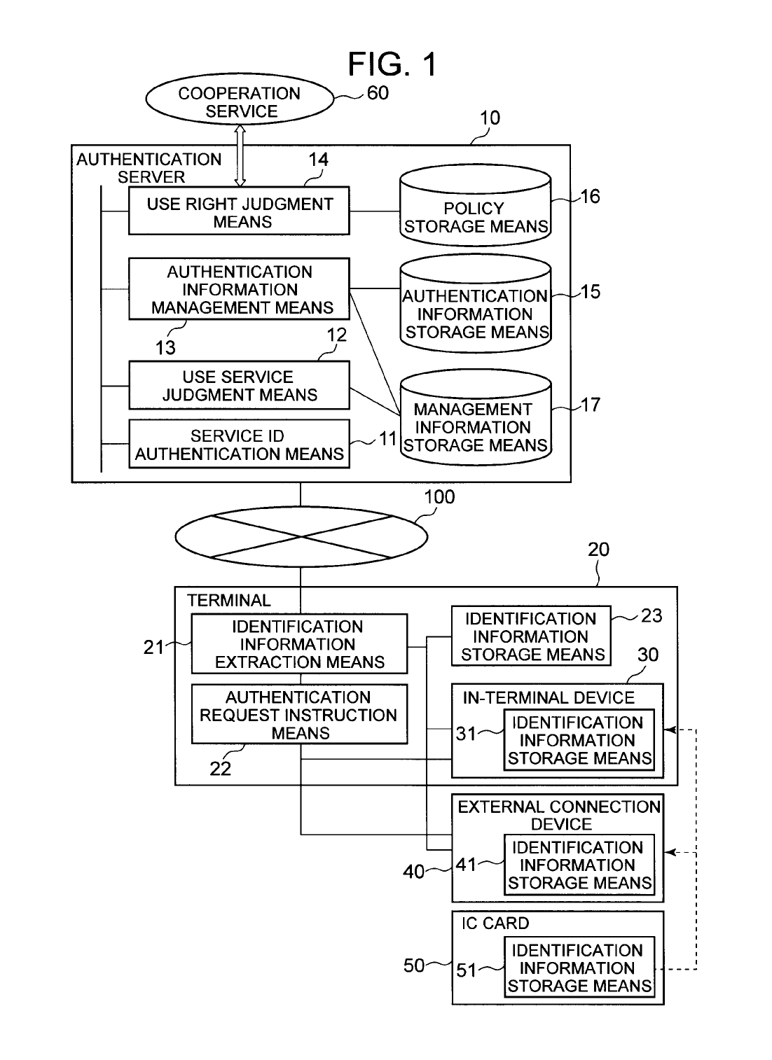

FIG. 1 is a block diagram illustrating an exemplary structure of a first exemplary embodiment of an authentication system according to the present invention. The authentication system according to the present exemplary embodiment includes an authentication server 10 and a terminal 20. The authentication server 10 authenticates a user utilizing a cooperation service 60. The terminal 20 requests the authentication server 10 to authenticate the cooperation service 60. The cooperation service 60 may be simply denoted as service in the following description.

FIG. 1 illustrates a case in which the authentication system includes one terminal 20, but the number of terminals 20 may be two or more, not limited to one. FIG. 1 illustrates a case in which the authentication system includes one authentication server 10, but the number of authentication servers 10 may be two or more, not limited to one. In this case, the processings described later may be distributed to the authentication servers 10 depending on processing loads or the number of connected terminals 20. Each authentication server 10 is connected to each terminal 20 via a communication network 100.

The terminal 20 includes an identification information extraction means 21, an authentication request instruction means 22, and an identification information storage means 23. In the authentication system illustrated in FIG. 1, an in-terminal device 30 including an identification information storage means 31 is incorporated in the terminal 20. In the authentication system illustrated in FIG. 1, an external connection device 40 including an identification information storage means 41 is connected to the terminal 20. In the following description, the state of the in-terminal device 30 incorporated in the terminal 20 may be denoted as being connected to the terminal 20. The contents of the identification information storage means 31 and the identification information storage means 41 will be described below.

The terminal 20 according to the present exemplary embodiment may be connected with at least one of the in-terminal device 30 and the external connection device 40. Both the in-terminal device 30 and the external connection device 40 may be connected to the terminal 20. The numbers of in-terminal devices 30 and external connection devices 40 are not limited to one, respectively, and two or more devices may be connected to the terminal 20, respectively. The functions of the in-terminal device 30 and the external connection device 40 may be the same or may be different. The in-terminal device 30 and the external connection device 40 are accomplished by a card reader/writer for reading information stored in an identification information storage means 51 provided in an IC card 50 described later, and writing information therein.

The IC card 50 includes the identification information storage means 51. The IC card 50 is used for identifying a user utilizing a service provided via the authentication system according to the present exemplary embodiment. That is, the IC card 50 may be a medium used for authenticating a user.

The identification information storage means 51 stores user identification information therein. For example, the in-terminal device 30 or the external connection device 40 makes non-contact communication with the IC card 50 by use of a standard such as Mifare (trademark) so that each item of information stored in the identification information storage means 51 is transmitted to the terminal 20. A communication method between the in-terminal device 30 or the external connection device 40 and the IC card 50 is not limited to the method using the Mifare standard.

The present exemplary embodiment will be described assuming that an IC card is used for identifying a user, but the form of a medium or device used for identifying a user is not limited to an IC card. For example, the identification information storage means 51 is incorporated in a device such as portable terminal so that the portable terminal can be used similarly to the IC card 50 according to the present exemplary embodiment.

The identification information storage means 51 desirably has high tamper resistance. Thus, the identification information storage means 51 according to the present exemplary embodiment is assumed to be accomplished by authenticated LSI (Large Scale Integration, which will be denoted as authenticated LSI below). The authenticated LSI is accomplished by a microcontroller chip, for example.

To each authenticated LSI is given unique identification information, and a medium and a terminal each including the authenticated LSI can be uniquely identified by the identification information. The authenticated LSI is held with each item of data encrypted, and the data is exchanged with each device while the data is being encrypted. That is, the user identification information is stored in the authenticated LSI in an encrypted state. A method for decrypting the encrypted information is recognized by a service ID authentication means 11 described later, and authorized information is decrypted by the service ID authentication means 11.

The unique identification information given to the authenticated LSI is non-rewritable information and can be falsified. The information stored in the authenticated LSI is later rewritable, but the stored information is encrypted and thus can be falsified. As described above, the authenticated LSI used in the present exemplary embodiment may have a set of non-rewritable information securing uniqueness and encrypted rewritable information.

The identification information storage means 31 and the identification information storage means 41 described above are also accomplished by the authenticated LSI similarly to the identification information storage means 51. That is, the in-terminal device 30 is uniquely identified by the authenticated LSI-specific identification information given to the identification information storage means 31. Similarly, the in-terminal device 40 is uniquely identified by the authenticated LSI-specific identification information given to the identification information storage means 41. In this way, the in-terminal device 30, the in-terminal device 40 and the IC card 50 used for authentication each include an authenticated LSI, and each device or each medium can be identified by specific identification information given to each authenticated LSI. In the following, identification information capable of uniquely identifying an authenticated LSI provided in a medium (such as the IC card 50) or device (such as the in-terminal device 30 or the in-terminal device 40) used for authenticating a user utilizing a service will be denoted as physical ID. As stated above, the physical ID is non-rewritable information. Uniqueness of the physical ID is secured by each bender, for example.

As the user identification information is stored in the identification information storage means 51, identification information defined per type of each device is stored in the identification information storage means 31 and the identification information storage means 41. For example, when the identification information storage means 31 is a card reader/writer, the identification information storage means 31 stores a card reader/writer ID as identification information therein. The device identification information stored in the identification information storage means 31 or the identification information storage means 41 and the user identification information stored in the identification information storage means 51 are used when a use right judgment means 14 described later judges a service use right. Thus, identification information defined per type of each medium or each device will be denoted as service ID below.

For example, when the user puts the IC card 50 over the card reader/writer accomplished by the in-terminal device 30 (or external connection device 40), the physical ID and the service ID stored in the identification information storage means 51 are transmitted to the in-terminal device 30 (or external connection device 40). In other words, the in-terminal device 30 (or external connection device 40) reads the physical ID and service ID stored in the identification information storage means 51. A control unit (not illustrated) in the in-terminal device 30 (or external device 40) notifies the received physical ID and service ID to the authentication request instruction means 22.

The identification information storage means 23 stores terminal identification information therein. The identification information storage means 23 according to the present exemplary embodiment is accomplished by an authenticated LSI similarly to the identification information storage means 51. That is, the terminal 20 is uniquely identified by the authenticated LSI-specific identification information given to the identification information storage means 23.

The authentication request instruction means 22 instructs the identification information extraction means 21 to extract the service ID from the identification information storage means provided in each device (specifically, the terminal 20, the in-terminal device 30 or the external connection device 40). The authentication request instruction means 22 may instruct the identification information extraction means 21 to extract the physical ID from each device.

The authentication request instruction means 22 holds terminal-specific information (such as device structure, authenticated LSI structure and data structure). A device from which the service ID is to be extracted is previously defined in a setting file or the like, for example, based on the terminal-specific information. The authentication request instruction means 22 may instruct the identification information extraction means 21 to extract the service ID according to the contents of the setting file.

When being notified of the physical ID and service ID read from the IC card 50, for example, the authentication request instruction means 22 may instruct the identification information extraction means 21 to extract the service ID. When the terminal 20 is powered on, the authentication request instruction means 22 may instruct the identification information extraction means 21 to extract the service ID. A timing when the authentication request instruction means 22 instructs to extract the service ID is not limited to the above timings. A timing when the service ID is instructed to extract may be previously defined per service to be used.

Additionally, the authentication request instruction means 22 may transmit user identification information (such as characteristic points of fingerprint or vein, or characteristic points of face image) specified by human physical characteristics or behavior characteristics to the authentication server 10 in response to a request from the authentication server 10. The information is transmitted so that options for authentication can be expanded.

The authentication request instruction means 22 is accomplished by a CPU of a computer operating according to a program. For example, the program is stored in a storage unit (not illustrated) of the terminal 20, and the CPU reads the program and may operate as the authentication request instruction means 22 according to the program.

The identification information extraction means 21 extracts the service ID from the identification information storage means provided in each device (specifically, the terminal 20, the in-terminal device 30 or the external connection device 40) in response to an instruction from the authentication request instruction means 22. In the present exemplary embodiment, the identification information extraction means 21 reads the service ID stored in the authenticated LSI in each medium or each device in an encrypted state. Then, the identification information extraction means 21 transmits a request of authenticating the extracted service ID together with the physical ID to the authentication server 10. A target of the physical ID transmitted by the identification information extraction means 21 is previously defined according to a requested service. That is, the identification information extraction means 21 transmits the previously-defined physical ID and one or more service IDs to the authentication server 10.

Herein, the service ID to be transmitted is encrypted and confidential information, and thus the information to be transmitted to the authentication server 10 may be denoted as confidential encrypted information. In the present exemplary embodiment, the identification information extraction means 21 is assumed to transmit the identification information of the identification information storage means 51 given to the IC card 50 as physical ID to the authentication server 10.

The identification information extraction means 21 is accomplished by a CPU of a computer operating according to a program. The program is accomplished by a driver for controlling each device connected to the terminal 20 or a common module accepting a lower-ordered device-dependent difference and not depending on a service or terminal, for example. Such a module is used so that a service ID can be extracted from an added device by only modifying the module when the new device is added, without changing the interface with a higher-ordered program.

The authentication server 10 includes the service ID authentication means 11, a use service judgment means 12, an authentication information management means 13, the use right judgment means 14, an authentication information storage means 15, a policy storage means 16 and a management information storage means 17.

When receiving an authentication request from the identification information extraction means 21, the service ID authentication means 11 judges validity of each received service ID. The service ID authentication means 11 decrypts the encrypted service ID. Specifically, the service ID authentication means 11 decrypts the confidential encrypted information transmitted from the terminal 20 thereby to judge whether the transmitted service ID is the information transmitted from a predetermined authenticated LSI. When the service ID is the information transmitted from a predetermined authenticated LSI, the service ID authentication means 11 judges that the service ID is valid. The service ID authentication means 11 may judge validity of the authenticated LSI by mutually exchanging a certificate between the authenticated LSI and the authentication server 10, for example.

The service ID to be authenticated indicates information for identifying a physical medium or device, and thus in the following description, the service ID authentication means 11 may denote validity judgment of a service ID as physical authentication or physical validity authentication.

The service ID authentication means 11 notifies information added with a validity judgment result (which may be denoted as authentication result below) per service ID and the physical ID to the use service judgment means 12. The service ID authentication means 11 may add information indicating a judgment result of “true” to a service ID decrypted for a device, and may add information indicating a judgment result of “false” to a decryption-failed service ID, for example. The service ID authentication means 11 notifies the information in which each service ID is added with the judgment result to the use service judgment means 12. The judgment result may be denoted as physical authentication status.

Information is previously shared between the terminal 20 and the authentication server 10 as to which service ID is to be authenticated.

The management information storage means 17 stores therein a list of physical IDs for identifying a medium or device permitted to use a service. The management information storage means 17 may store therein a list of service IDs assumed to be used. The physical ID stored in the management information storage means 17 is used for judgment by the use service judgment means 12 described later. The service IDs stored in the management information storage means 17 are used for judgment by the authentication information management means 13 described later.

The use service judgment means 12 judges availability of a service utilizing a medium or device identified by a physical ID based on the physical ID received from the service ID authentication means 11.

Specifically, when the received physical ID is stored in the management information storage means 17, the use service judgment means 12 judges that a service utilizing the medium or device identified by the physical ID is available. Then, the use service judgment means 12 transmits the service ID and authentication result received from the service ID authentication means 11 to the authentication information management means 13. The use service judgment means 12 transmits the service ID to the authentication information management means 13 based on the received judgment result of the physical ID, and thus a processing performed by the use service judgment means 12 may be denoted as ID handling.

On the other hand, when the received physical ID is not stored in the management information storage means 17, the use service judgment means 12 judges that a service utilizing the medium or device identified by the physical ID is not available. Then, the use service judgment means 12 notifies error information indicating unavailable service to the terminal 20. The terminal 20 receiving the error may display the information indicating unavailable service on a display unit (not illustrated) such as display.

The authentication information storage means 15 stores the service ID and authentication result contained in one authentication request transmitted from the terminal 20 in an associated manner. In the present exemplary embodiment, a combination of one or more service IDs capable of identifying one authentication request made by the user among the service IDs received from the terminal 20 may be previously defined as key ID. That is, the key ID may be a combination of one or more service IDs capable of identifying a user-made authentication request among the received service IDs. For example, the identification information of the user utilizing a service is previously defined as key ID among the service IDs received from the terminal 20. At this time, the authentication information storage means 15 stores other service ID and authentication result in association with the user identification information as key ID. A service ID selected as key ID is not limited to the user identification information.

In the following description, not only a service ID selected as key ID, but also information combining therein a service ID selected as key ID and a physical ID for identifying a medium or device storing the service ID may be denoted as key ID. A physical ID and a service ID correspond to each other on one-to-one basis, and thus a physical ID corresponding to a service ID selected as key ID may be denoted as key physical ID.

The authentication information storage means 15 may associate and store other information on a user-made authentication request with a key ID, other than a service ID and an authentication result. Other information includes information for identifying a network utilized by the user for an authentication request (which will be denoted as network identification information below), time/date when the user requests authentication, time/date when the authentication processing is performed, time/date when the information is registered in the authentication information storage means 15, and the like, for example. The network identification information includes a path on the network, information on a routed device, and the like. The information in addition to a service ID and an authentication result may be denoted as key ID attribute information.

The authentication information storage means 15 may store a plurality of items of identification information on the user making a service request. The authentication information storage means 15 may store user identification information specified by human physical characteristics or behavior characteristics such as characteristic points extracted from the user's face image or characteristic points extracted from a user's fingerprint or vein in association with the user making an authentication request.

The authentication information management means 13 stores the service ID and authentication result received from the use service judgment means 12 in the authentication information storage means 15. Specifically, when the use service judgment means 12 judges that a service utilizing the medium or device identified by the received physical ID is available, the authentication information management means 13 stores the service ID and authentication result contained in one authentication request transmitted from the terminal 20 in the authentication information storage means 15 in an associated manner.

The information stored in the authentication information storage means 15 by the authentication information management means 13 is not limited to a service ID and an authentication result. The authentication information management means 13 may store information such as network identification information and authentication request time/date in the authentication information storage means 15.

When an authentication request is made from the cooperation service 60 (specifically, a service providing device) to the authentication server 10, the authentication information management means 13 may notify the service ID to the device. Specifically, when an authentication request is made from the cooperation service 60 while user identification information or information to be requested is designated, the authentication information management means 13 may extract information identified by the authentication request from the authentication information storage means 15 and return the extracted information to the service providing device.

The same key ID as the key ID specified by the information received from the use service judgment means 12 may be previously stored in the authentication information storage means 15. At this time, the authentication information management means 13 may update the original information with the received information. That is, when receiving an authentication request identified by the same key ID previously stored in the authentication information storage means 15, the authentication information management means 13 may update the information corresponding to the key ID with the information contained in the authentication request. In this way, the authentication processing can be performed in favor of new information.

The authentication information management means 13 may delete the information which has been stored for a predetermined period of time in the authentication information storage means 15. When receiving an explicit delete instruction for the information stored in the authentication information storage means 15, the authentication information management means 13 may delete the information specified by the delete instruction. For example, when one authentication request transmitted from the terminal 20 is specified with the user identification information as key ID, the authentication information management means 13 may delete the authentication request information identified by the key ID from the authentication information storage means 15. In this way, the old information is prevented from being used for the authentication processing.

The authentication information management means 13 may determine whether the received service ID is stored in the management information storage means 17. When the received service ID is stored in the management information storage means 17, the authentication information management means 13 may store the service ID in the authentication information storage means 15. On the other hand, when the received service ID is not stored in the management information storage means 17, the authentication information management means 13 may notify error information indicating the absence of the service ID to the terminal 20. At this time, the terminal 20 receiving the error may display the information indicating the absence of the service ID on the display unit (not illustrated) such as display.

In the following description, the processings performed by the authentication information management means 13 may be collectively denoted as ID authentication/management.

The policy storage means 16 stores therein a policy which defines a service available range depending on at least a service ID or a combination of service ID and authentication result. The service available range contains information indicating service availability, or information indicating that a specific function is available in the service.

The policy may be defined by use of either one of the service ID and the authentication result or by use of both of them. The elements defining a policy are not limited to a service ID and an authentication result. The policy may be defined by use of a path or time where or when the user makes a service authentication request. The service ID or authentication result defining a policy at least needs to be contained in the information stored in the authentication information storage means 15.

The use right judgment means 14 judges user's service use right by the service ID and the authentication result in association with the key ID stored in the authentication information storage means 15 based on the policy stored in the policy storage means 16.

Specifically, the service ID associated with the key ID contains information capable of identifying the user. Thus, the use right judgment means 14 judges whether each item of information indicating the service authentication request by the user stored in the authentication information storage means 15 meets a requirement for utilizing the service defined by the policy.

For example, when the policy contains information indicating a network or time, the use right judgment means 14 may judge a use right of the service utilized by the user by the information indicating a network or time stored in the authentication information storage means 15 based on the policy. The use right judgment means 14 notifies a judgment result indicating service availability to the inquiry source. When the user identification information specified by human physical characteristics or behavior characteristics is contained in the authentication information storage means 15, the use right judgment means 14 may use the information for judging the use right.

A request of authenticating user's service use right may be made from the terminal 20 or the service 60 (specifically, a service providing device). When the authentication request is made from the terminal 20, the use right judgment means 14 notifies a judgment result to the terminal 20. When the authentication request is made from the service 60, the use right judgment means 14 notifies a judgment result to the service providing device.

When the authentication request made by the user meets a requirement defined by the policy, the use right judgment means 14 judges that the user can use the service. For example, when the authentication request is made from the terminal 20, the use right judgment means 14 may notify information indicating that the service is available to the terminal 20.

On the other hand, when the authentication request made by the user does not meet a requirement defined by the policy, the use right judgment means 14 judges that the user cannot use the service. For example, when the authentication request is made from the terminal 20, the use right judgment means 14 may notify the information indicating that the service is unavailable to the terminal 20. In the following description, the processings performed by the use right judgment means 14 may be denoted as authentication service.

The service ID authentication means 11, the use service judgment means 12, the authentication information management means 13 and the use right judgment means 14 are accomplished by a CPU of a computer operating according to a program (authentication program). For example, the program is stored in a storage unit (not illustrated) of the authentication server 10, and the CPU reads the program and may operate as the service ID authentication means 11, the use service judgment means 12, the authentication information management means 13 and the use right judgment means 14 according to the program. The service ID authentication means 11, the use service judgment means 12, the authentication information management means 13 and the use right judgment means 14 may be accomplished by dedicated devices, respectively.

The authentication information storage means 15, the policy storage means 16 and the management information storage means 17 are accomplished by a magnetic disk or a hard disk device, respectively. The authentication information storage means 15, the policy storage means 16 and the management information storage means 17 may be provided in separate devices or provided in the same device.

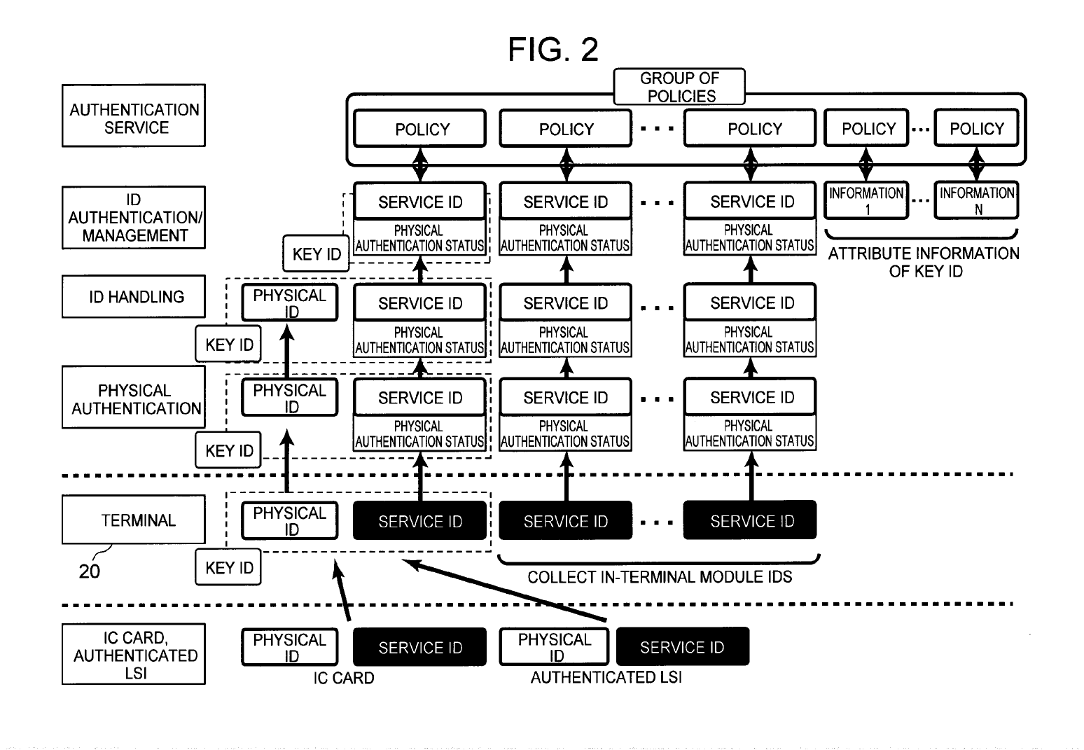

A flow of data used in the authentication system according to the present exemplary embodiment will be described below. FIG. 2 is an explanatory diagram illustrating an exemplary flow of data. The service ID described in white characters illustrated in FIG. 2 indicates encrypted data prior to being authenticated. The service ID described in black characters indicates decrypted data after being authenticated. The key ID herein is assumed as a service ID stored in the IC card or authenticated LSI.

The terminal 20 reads the physical ID and the encrypted service ID from the IC card or authenticated LSI. The terminal 20 reads the service ID of the module incorporated in the terminal. Then, the terminal 20 transmits the physical ID and the encrypted service ID to the authentication server 10 in a previously-defined order.

The service ID authentication means 11 performing physical authentication decrypts the encrypted service ID thereby to make a judgment (or authentication processing) on validity of the service ID. The service ID authentication means 11 sets the judgment result at a physical authentication status, and transmits it to the use service judgment means 12.

The use service judgment means 12 performing ID handling judges availability of the service based on the physical ID. When it is determined that the service is available, the use service judgment means 12 transmits the service ID and the physical authentication status to the authentication information management means 13.

The authentication information management means 13 performing ID authentication/management stores the service ID and physical authentication status received from the use service judgment means 12, and the key ID attribute information to the authentication information storage means 15.

The use right judgment means 14 performing an authentication service judges a use right of the service to be utilized by the user based on the previously-defined policy.

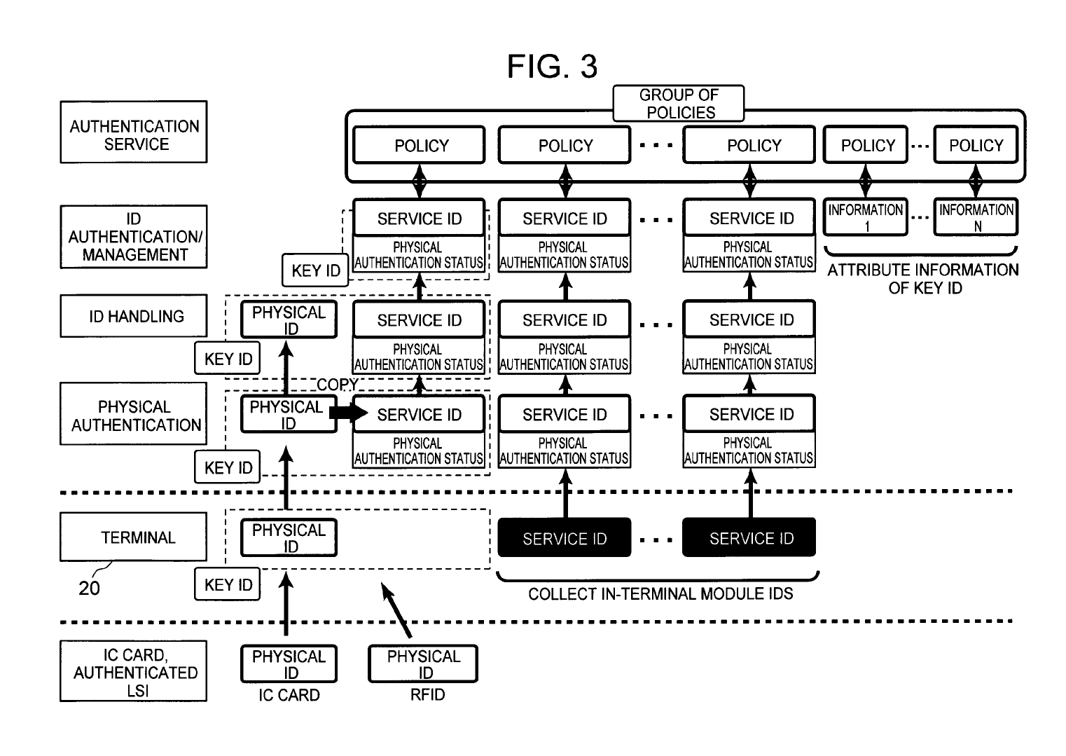

Other flow of data used in the authentication system according to the present exemplary embodiment will be described below. FIG. 3 is an explanatory diagram illustrating other exemplary flow of data. The contents of items illustrated in FIG. 3 are similar to the contents illustrated in FIG. 2. It is assumed herein that only the physical ID is stored in the IC card or RFID (Radio Frequency IDentification) tag and the service ID is not stored therein. Thus, the key ID is the physical ID (or key physical ID only).

The processing is performed when an inexpensive IC card or RFID tag is selected as an authentication card.

The terminal 20 reads the physical ID from the IC card or RFID tag. The terminal 20 reads the service ID of the module incorporated in the terminal. The terminal 20 transmits the physical ID and the encrypted service ID to the authentication server 10 in a previously-defined order.

The service ID authentication means 11 performing physical authentication makes a judgment (or authentication processing) on validity of the service ID. The service ID authentication means 11 copies the physical ID as the service ID used as key ID. Herein, the physical authentication status may be set at a status indicating “undone”. The service ID authentication means 11 sets a judgment result for each service ID at a physical authentication status, and transmits it to the use service judgment means 12. The subsequent processings are similar to the ID handling, the ID authentication and the authentication service illustrated in FIG. 2.

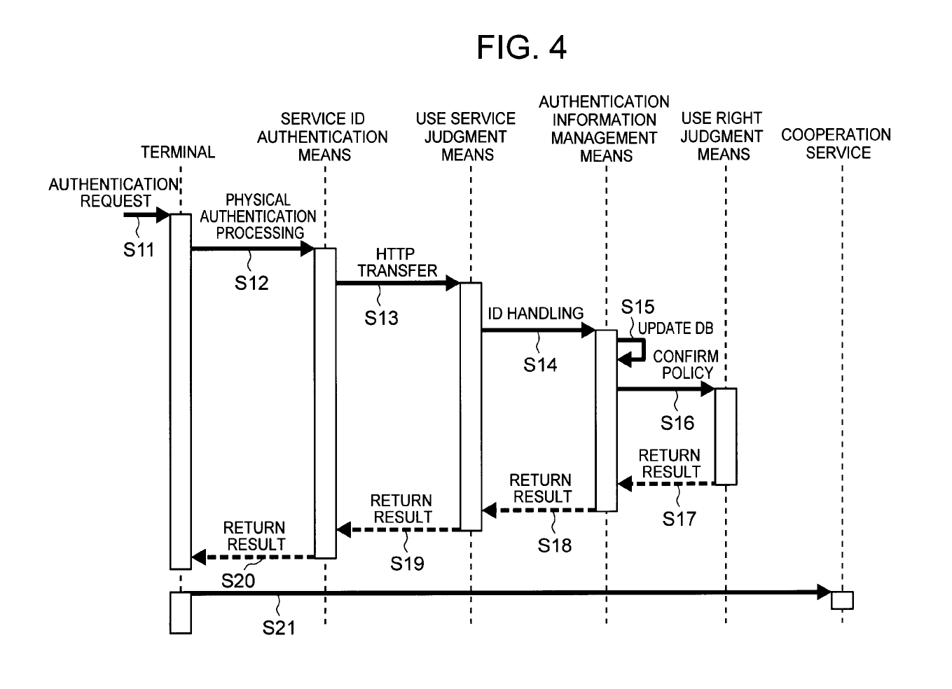

The operations of the authentication system according to the present exemplary embodiment will be described below. At first, the operations when a service authentication request is made by the user from the terminal 20 and its authentication result is notified to the terminal 20 will be described. The use right judgment means 14 is assumed to perform a processing of judging a use right when the use service judgment means 12 judges that the service is available. FIG. 4 is a sequence diagram illustrating exemplary authentication processings of the authentication system according to the present exemplary embodiment.

When the user puts the IC card 50 over the in-terminal device 30 or the external connection device 40 to make a service authentication request (step S11), the in-terminal device 30 or the external connection device 40 reads the physical ID and the service ID stored in the identification information storage means 51. Then, the in-terminal device 30 or the external connection device 40 notifies the physical ID and the service ID to the authentication request instruction means 22.

When receiving the notification containing the physical ID and the service ID, the authentication request instruction means 22 instructs the identification information extraction means 21 to extract the service ID from the identification information storage means in each device. At this time, the authentication request instruction means 22 is assumed to instruct the identification information extraction means 21 to extract the key ID and the service ID of the medium or device to be authenticated in a designated order of them. The objects to be authenticated in the present exemplary embodiment are the IC card 50 and the in-terminal device 30 or the external connection device 40. The order of the service IDs is the service ID of the IC card 50 and then the service ID of the in-terminal device 30 or the external connection device 40. The key ID is assumed as the service ID of the IC card 50.

The identification information extraction means 21 extracts the service ID from the identification information storage means in each device and requests the service ID authentication means 11 in the authentication server 10 to perform the physical authentication processing (step S12). That is, when the identification information extraction means 21 transmits the service ID to the service ID authentication means 11, the service ID authentication means 11 judges validity of the service ID. The identification information extraction means 21 transmits the physical ID to the service ID authentication means 11.

In the present exemplary embodiment, the service ID authentication means 11 transfers a validity judgment result (authentication result) to the use service judgment means 12 by use of HTTP (Hypertext Transfer Protocol) (step S13). At this time, the service ID authentication means 11 collectively transmits the information used for one authentication to the use service judgment means 12.

The use service judgment means 12 judges availability of the service based on the physical ID received from the service ID authentication means 11. The use service judgment means 12 transmits an authentication result to the authentication information management means 13 based on the judgment result. That is, the use service judgment means 12 performs ID handling (step S14).

The authentication information management means 13 updates the information stored in the authentication information storage means 15 based on the service ID and the contents of the authentication result received from the use service judgment means 12 (step S15). Herein, the authentication information management means 13 stores the information received from the use service judgment means 12 in the authentication information storage means 15 with the service ID (such as employee ID card number) stored in the IC card 50 as key ID.

When the use service judgment means 12 judges that the service is available, the use right judgment means 14 judges user's service use right based on the policy stored in the policy storage means 16 (step S16). The use right judgment means 14 transmits the judgment result of the service use right to the terminal 20 via the authentication information management means 13, the use service judgment means 12 and the service ID authentication means 11 (steps S17 to S20). Subsequently, the terminal 20 directly uses the service to perform the processings (step S21).

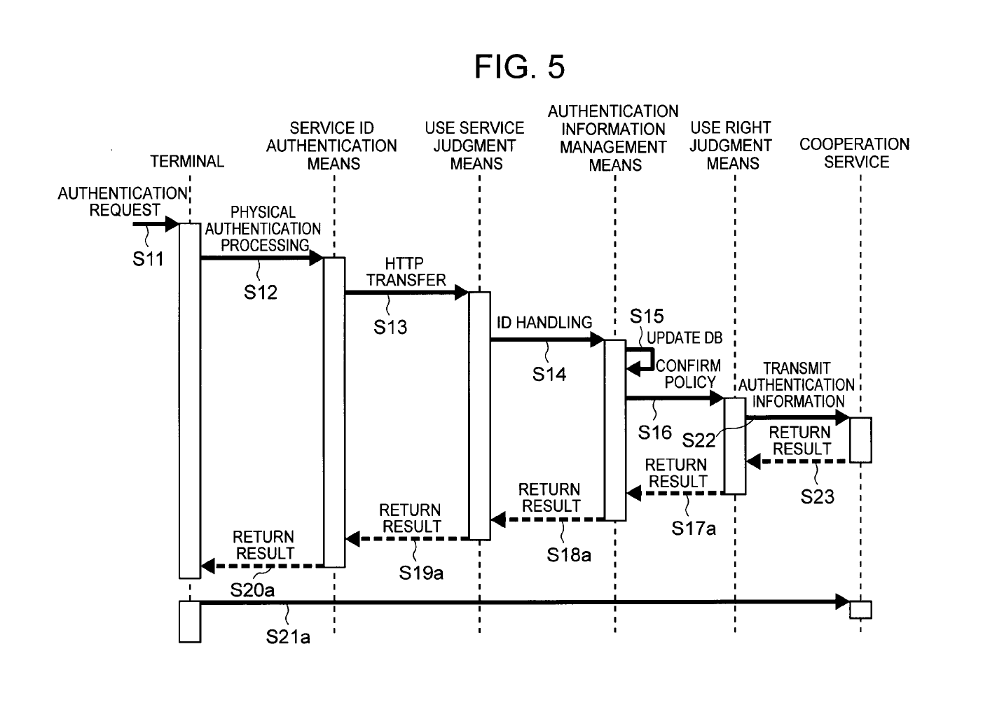

Other operations of the authentication system according to the present exemplary embodiment will be described below. Herein, there will be described the operations when a service authentication request is made by the user from the terminal 20 to notify an authentication result to the service and the authentication result judged by the service is notified to the terminal 20. FIG. 5 is a sequence diagram illustrating other exemplary authentication processings. The processings in step S11 to step S16 in which an authentication request is made by the user and the use right judgment means 14 judges user's service use right are similar to the contents illustrated in FIG. 4, and thus a detailed explanation thereof will be omitted.

The use right judgment means 14 judges user's service use right, and then notifies authentication information indicating the judgment result to the service (step S22). When the service notifies the result of the processing based on the authentication information to the use right judgment means 14 (step S23), the use right judgment means 14 transmits the processing result by the service to the terminal 20 via the authentication information management means 13, the use service judgment means 12 and the service ID authentication means 11 (steps S17a to S20a). Subsequently, the terminal 20 directly uses the service to perform the processings (step S21a).

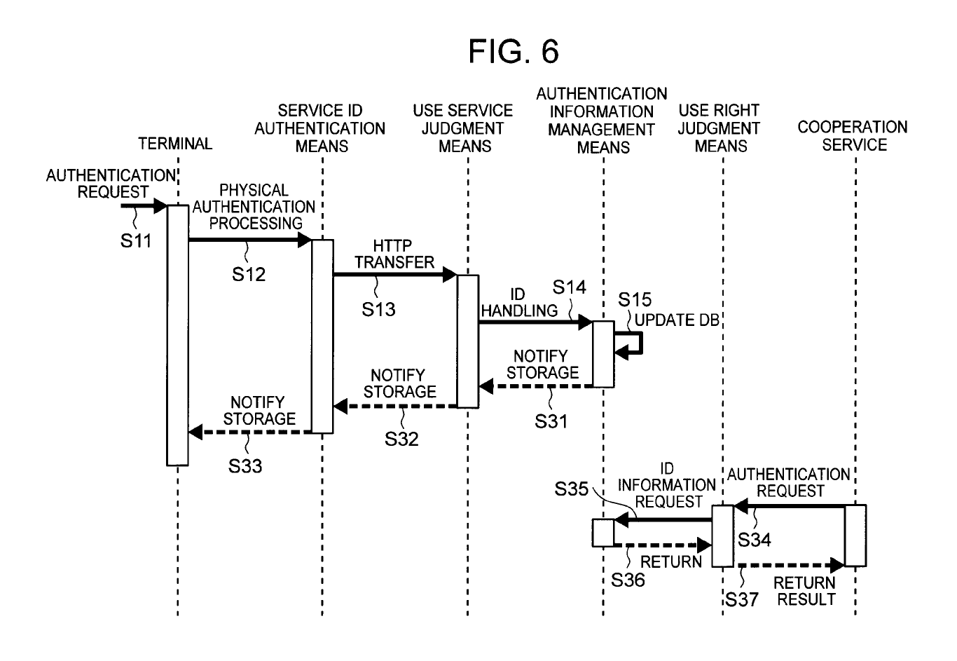

Other operations of the authentication system according to the present exemplary embodiment will be described below. Herein, there will be described the operations when only a service ID and a physical ID are authenticated and a service use right is not judged by the policy. FIG. 6 is a sequence diagram illustrating other exemplary authentication processings. The processings in step S11 to step S15 in which an authentication request is made by the user and the authentication information management means 13 stores the received information in the authentication information storage means 15 are similar to the contents illustrated in FIG. 4, and thus a detailed explanation thereof will be omitted.

The authentication information management means 13 notifies the information indicating that the information is stored in the authentication information storage means 15 to the terminal 20 via the use service judgment means 12 and the service ID authentication means 11 (steps S31 to S33). Thereafter, when the use right judgment means 14 asynchronously receives a service ID authentication request from the service (step S34), the use right judgment means 14 requests the service ID stored in the authentication information storage means 15 and the policy stored in the policy storage means 16 to the authentication information management means 13 (step S35). When the authentication information management means 13 returns the ID information to the use right judgment means 14 (step S36), the use right judgment means 14 authenticates the user based on the information. The use right judgment means 14 returns the judgment result to the service (step S37).

As described above, according to the present exemplary embodiment, the identification information extraction means 21 transmits the physical ID and the service ID to the authentication server 10. Specifically, the identification information extraction means 21 transmits the physical ID of a previously-defined medium or device among one or more mediums or devices used for authentication, and one or more previously-defined service IDs in the medium or device used for authentication to the authentication server 10.

Then, the service ID authentication means 11 judges validity of each received service ID, and the use service judgment means 12 judges availability of the service using the medium or device identified by a physical ID based on the received physical ID. When it is judged that the service is available, the authentication information management means 13 stores at least a service ID and a validity judgment result of the service ID in association with a key ID in the authentication information storage means 15. The use right judgment means 14 judges the use right of the service used by the user from the service ID and the judgment result of the service ID in association with the key ID stored in the authentication information storage means 15 based on the policy.

Thus, high-level authentication control can be dynamically performed depending on an environment in which the user utilizes a service. That is, the information used for judging validity of a service ID is physically stored in the authenticated LSI of a medium or device, and the information used for judging availability of a service is the physical ID given to the medium or device. Thus, the authentication system according to the present exemplary embodiment can perform authentication control based on information specified by an environment in which a service is utilized.

The authentication system according to the present exemplary embodiment utilizes a combination of non-rewritable information securing uniqueness and encrypted rewritable information. In this way, security can be further enhanced and authentication can be more flexibly performed as compared with the use of only rewritable information or non-rewritable information.

A validity judgment result of each service ID is stored in the authentication information storage means 15. The information stored in the authentication information storage means 15 is compared with the policy thereby to judge a service use right. The contents of the policy can be dynamically changed depending on a service available range. For example, even when some service IDs are not valid, if the service judges that the service IDs do not need to be authenticated, the policy therefor may be defined. The policy can set any requirement for information which can be acquired on authentication request. That is, the authentication system according to the present exemplary embodiment can dynamically perform authentication control.

### Second Exemplary Embodiment

A second exemplary embodiment of the authentication system according to the present invention will be described below. An available service is specified in the first exemplary embodiment. In the present exemplary embodiment, a plurality of available services are present and the user utilizes one of them.

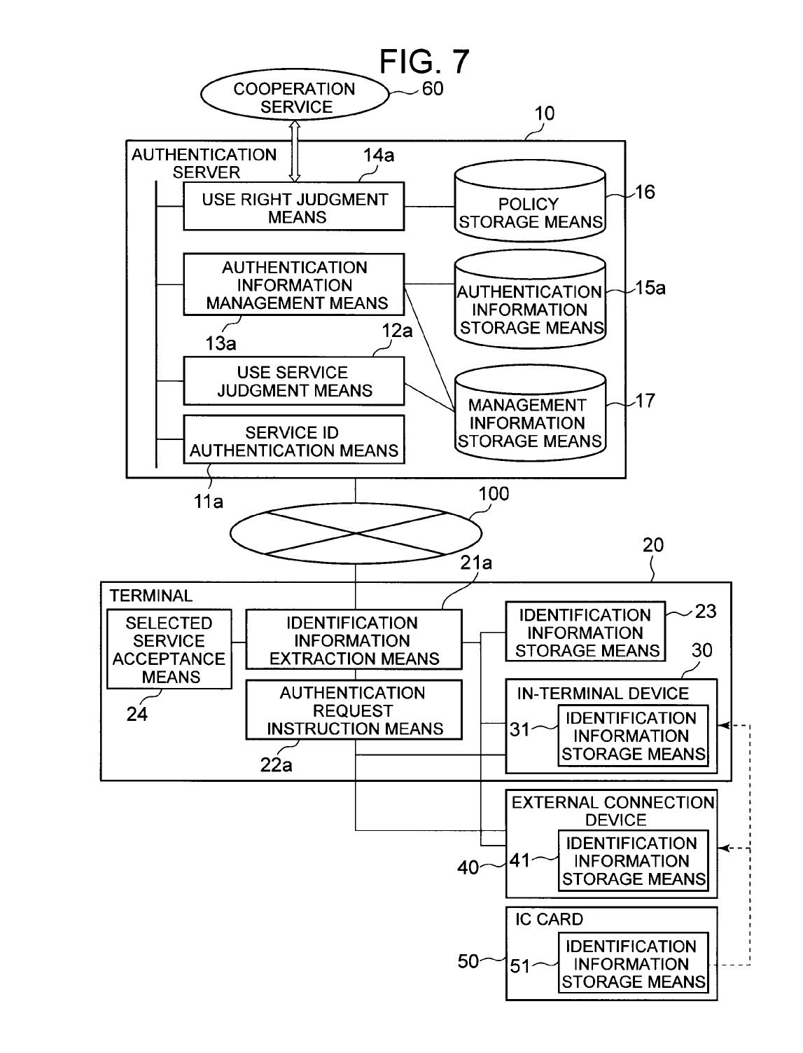

FIG. 7 is a block diagram illustrating an exemplary structure of the second exemplary embodiment of the authentication system according to the present invention. The same constituents as those in the first exemplary embodiment are denoted with the same reference numerals as in FIG. 1, and an explanation thereof will be omitted. The authentication system according to the present exemplary embodiment also includes the authentication server 10 and the terminal 20. Each authentication server 10 is connected to each terminal 20 via the communication network 100.

The terminal 20 includes an identification information extraction means 21a, an authentication request instruction means 22a, the identification information storage means 23 and a selected service acceptance means 24. Also in the authentication system according to the present exemplary embodiment, the in-terminal device 30 including the identification information storage means 31 and the external connection device 40 including the identification information storage means 41 are connected to the terminal 20. That is, the terminal 20 according to the present exemplary embodiment is different from the terminal 20 according to the first exemplary embodiment in that it includes the identification information extraction means 21a instead of the identification information extraction means 21 and the authentication request instruction means 22a instead of the authentication request instruction means 22. The terminal 20 according to the present exemplary embodiment is different from that in the first exemplary embodiment in that it includes the selected service acceptance means 24. Other contents are the same as in the first exemplary embodiment.

The authentication request instruction means 22a instructs the identification information extraction means 21a to extract a service ID from the identification information storage means provided in each device similarly to the authentication request instruction means 22 according to the first exemplary embodiment. The authentication request instruction means 22a holds terminal-specific information similarly to the authentication request instruction means 22 according to the first exemplary embodiment.

In the present exemplary embodiment, since a plurality of available services are present, a device from which the service ID is to be extracted is determined based on the terminal-specific information per service used by the user. An identifier for identifying a service will be denoted as application code or app CD below. The app CD is previously determined by a provider of the authentication system, for example, to be unique per service cooperated with the authentication system. Such an app CD is used thereby to selectively activate a plurality of services by one ID. Specifically, a device from which the service ID is to be extracted is previously determined in a setting file or the like, for example, in association with the app CD.

That is, when an authentication request is made to the authentication server 10, the user can identify a service to be utilized by not only the user identification information but also the app CD given to the user identification information.

The authentication request instruction means 22a instructs the identification information extraction means 21a to extract a service ID depending on a service to be utilized by the user. The authentication request instruction means 22a may judge a service to be utilized based on a user's service designation method. When the user puts the IC card 50 over the in-terminal device 30 or the external connection device 40, for example, the authentication request instruction means 22a may specify the service for performing the processings illustrated in FIG. 4 as a service requested by the user. When the user powers on the terminal 20, for example, the authentication request instruction means 22a may specify the service for performing the processings illustrated in FIG. 6 as a service requested by the user. A method for judging which service is to be utilized by the user is not limited to the above method.

For example, it is assumed that the user puts the IC card 50 over the in-terminal device 30 or the external connection device 40 to make a service request for a plurality of services. In this case, the terminal 20 reads the IC card 50 and then displays a plurality of available services on a display unit (not illustrated), and the selected service acceptance means 24 described later may accept one service selected by the user. The authentication request instruction means 22a may instruct the identification information extraction means 21a to extract the service ID defined in the selected service.

The selected service acceptance means 24 accepts selection of a service to be utilized by the user. Specifically, when a plurality of services utilizing the terminal 20 are present, the selected service acceptance means 24 accepts a user-selected service and notifies the service to the authentication request instruction means 22a. At this time, the authentication request instruction means 22a instructs the identification information extraction means 21a to extract the service ID previously defined for the service accepted by the selected service acceptance means 24.

A service to be utilized by the user may be uniquely defined depending on a request form. For example, when it is defined that “a service to be utilized when the IC card 50 is put over the card reader is A service”, if the IC card 50 is put over the card reader, the user does not need to explicitly select a service. In this case, the terminal 20 may not include the selected service acceptance means 24.

The identification information extraction means 21a extracts the service ID from the identification information storage means provided in each device (specifically, the terminal 20, the in-terminal device 30 or the external connection device 40) in response to an instruction of the authentication request instruction means 22a. The identification information extraction means 21a transmits, to the authentication server 10, a combination of one or more service IDs previously defined per service, a physical ID, and an app CD for identifying a service to which the user makes an authentication request. The app CD is used for identifying a user-requested service.

The identification information extraction means 21a and the authentication request instruction means 22a are accomplished by a CPU of a computer operating according to a program. For example, the program is stored in the storage unit (not illustrated) of the terminal 20, and the CPU reads the program and may operate as the identification information extraction means 21a and the authentication request instruction means 22a according to the program.

The authentication server 10 includes a service ID authentication means 11a, a use service judgment means 12a, an authentication information management means 13a, a use right judgment means 14a, an authentication information storage means 15a, the policy storage means 16 and the management information storage means 17. The contents of the management information storage means 17 are the same as in the first exemplary embodiment, and thus a detailed explanation thereof will be omitted.

The service ID authentication means 11a judges validity of each received service ID similarly to the service ID authentication means 11 according to the first exemplary embodiment. The service ID authentication means 11a notifies information with the authentication result added to each service ID, a physical ID and an app CD to the use service judgment means 12a.

The use service judgment means 12a judges availability of a service utilizing the medium or device identified by a physical ID based on the physical ID received from the service ID authentication means 11a similarly to the use service judgment means 12 according to the first exemplary embodiment. Specifically, when a combination of received physical ID and app CD is stored in the management information storage means 17, the use service judgment means 12a judges that a service utilizing the medium or device identified by the physical ID is available. The use service judgment means 12a determines a transmission destination of the service ID based on the app CD received from the service ID authentication means 11a. That is, the use service judgment means 12a performs ID handling based on the app CD.

For example, when a device for performing the processings is different per service, the service ID is transmitted to a service providing device specified by the app CD. Herein, that a device for performing the processings is different indicates not only that each device is physically different but also that the physically same device is virtually distributed into a plurality of devices. A rule defining a correspondence between the app CD and the transmission destination of the service ID is previously stored in the management information storage means 17, and the use service judgment means 12a transmits the service ID to a transmission destination specified based on the rule.

When the same service is used by a plurality of companies (which may be denoted as tenant below), a handling destination is discriminated per tenant. Generally, a code scheme of the physical ID is different per tenant. Thus, the use service judgment means 12a may specify a company based on the code scheme of the physical ID.

Specifically, a group of physical IDs and information on companies (tenants) as information for identifying a company may be associated and previously stored in the management information storage means 17. The use service judgment means 12a may transmit the service ID to a transmission destination (tenant) specified based on the correspondence. The authentication processing is performed based on the setting so that a public cloud service described below can be provided.

The authentication information storage means 15a stores the service ID and the authentication result contained in one authentication request transmitted from the terminal 20 in association with the key ID similarly to the authentication information storage means 15 according to the first exemplary embodiment. At this time, the authentication information storage means 15a stores the app CD contained in each authentication request in association with the key ID. The authentication information storage means 15a stores the app CD together with the authentication request, and thus it is possible to identify for which service the user makes an authentication request.

A service ID to be authenticated is different per cooperation service. Therefore, service IDs to be authenticated, which are specified by the app CD, and the order of the service IDs are shared between the terminal 20 and the authentication server 10 (more specifically, the authentication information management means 13a). For example, the contents to be stored in the authentication information storage means 15a may be set to be the same as the contents of the terminal-specific information held by the authentication request instruction means 22a on introduction of the system (system integration). By doing so, the terminal 20 can determine which service ID to transmit per app CD and the authentication server 10 can determine which service ID to receive per app CD.

The authentication information management means 13a stores the app CD in the authentication information storage means 15a together with the service ID and the authentication result received from the use service judgment means 12a. Specifically, the authentication information management means 13a stores the received app CD in the authentication information storage means 15a in association with the key ID. Other functions are the same as the functions provided in the authentication information management means 13 according to the first exemplary embodiment.

The policy storage means 16 stores a policy defining availability of a service depending on at least a service ID or a combination of service ID and authentication result similarly to the first exemplary embodiment. The policy storage means 16 may store an app CD for identifying a service for which a use right is to be judged. In this case, the policy storage means 16 can be shared per service. When the same service is used in a plurality of tenants, the policy storage means 16 stores a policy defining availability of the service per tenant. In this case, availability of the service may be defined per combination of information for identifying each tenant and app CD.

The information for identifying each tenant may be contained in the app CD. That is, the app CD may contain the information for identifying each tenant. If the app CD is assigned by the code scheme combining a service and a tenant therein, the service and the tenant can be uniquely judged with reference to the app CD.

The use right judgment means 14a judges user's service use right from the service ID and the authentication result in association with the key ID stored in the authentication information storage means 15a based on the policy stored in the policy storage means 16 similarly to the use right judgment means 14 according to the first exemplary embodiment. In the present exemplary embodiment, the use right judgment means 14a judges user's use right for the service identified by the app CD. For example, when receiving the app CD and the key ID from the service, the use right judgment means 14a makes a judgment based on the policy and the information stored in the authentication information storage means 15a, and returns the authentication result to the service.

The service ID authentication means 11a, the use service judgment means 12a, the authentication information management means 13a and the use right judgment means 14a are accomplished by a CPU of a computer operating according to a program (authentication program). The service ID authentication means 11a, the use service judgment means 12a, the authentication information management means 13a and the use right judgment means 14a may be accomplished by dedicated devices, respectively.

The operations of the authentication system according to the present exemplary embodiment are different from those of the authentication system according to the first exemplary embodiment in that an app CD for identifying a service to be utilized is exchanged. Other operations are the same as in the first exemplary embodiment, and thus a detailed explanation thereof will be omitted.

As described above, according to the present exemplary embodiment, the identification information extraction means 21a transmits the combination of service IDs and the physical ID corresponding to the services for which the user makes an authentication request in association with the app CD to the authentication server 10, and the authentication information management means 13a stores the service ID and the judgment result in the authentication information storage means 15a in association with the key ID and the app CD. Then, the use right judgment means 14a judges user's use right for the service identified by the app CD. Therefore, in addition to the effects of the first exemplary embodiment, even when a plurality of user-available services are present, the authentication processing can be performed per service.

### EXAMPLE

The present invention will be described below by way of a specific example, but the scope of the present invention is not limited to the contents described below. In the present example, there will be described an example in which the present invention is applied to a public cloud widely provided for many users such as various companies, organizations and persons.

In the public cloud, a plurality of companies (which may be denoted as multi-tenant below) utilize a plurality of services (which may be denoted as multi-service below). Thus, there may be present a plurality of tenants utilizing the same service. In the present example, hardware resources are virtually divided into a plurality of tenants. Therefore, a new hardware resource does not need to be added each time a tenant increases, and thus the increase in tenants can be flexible addressed.

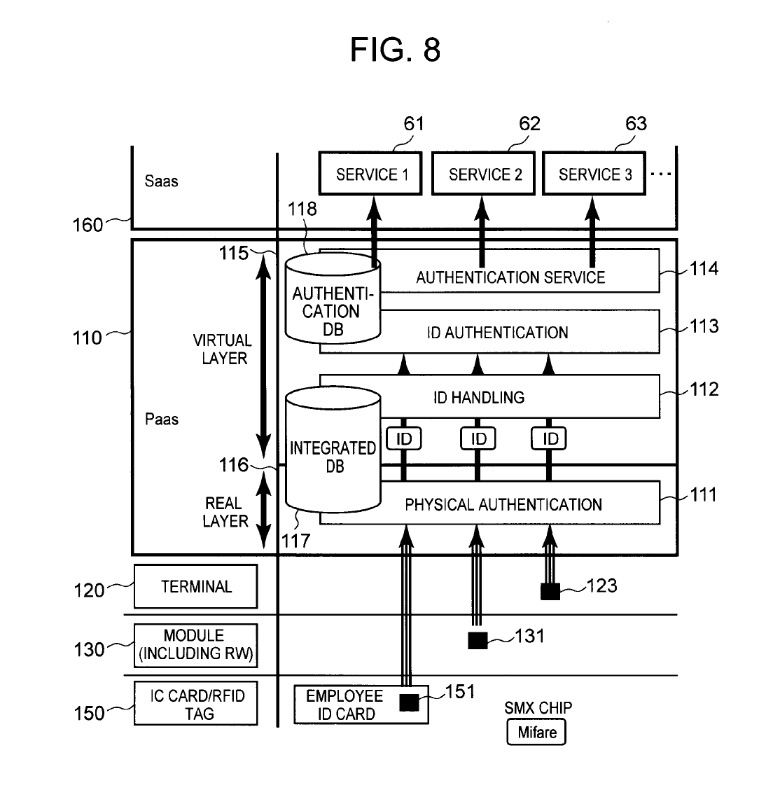

FIG. 8 is an explanatory diagram illustrating an exemplary cloud system to which the authentication system according to the present invention is applied. In the cloud system illustrated in FIG. 8, a SaaS layer 160 for providing a plurality of services (service 61 to service 63) via Internet and a PaaS layer 110 for providing a platform for executing the services via Internet are present. The PaaS layer 110 corresponds to the authentication server 10 according to the first exemplary embodiment.

In the cloud system illustrated in FIG. 8, a terminal 120 accesses the PaaS layer 110. A module 130 is connected to the terminal 120. The user puts an IC card (or RFID tag) 150 over the module 130 thereby to make an authentication request. In the present example, a SmartMX (trademark) chip (which will be denoted as SMX chip) using Mifare as a communication standard is used for LSI incorporated in the terminal 120, the module 130 and the IC card 150.

The terminal 120 previously defines therein app CDs for identifying a plurality of services, objects to be authenticated necessary for the services (specifically, service IDs), key IDs and a data order. Herein, the key ID is a header data of data to be transmitted. The position of the key ID is not limited to the header. If a data order is previously defined between the terminal 120 and the PaaS layer 110, the position of the key ID may not be at the header.

The module 130 reads the service ID for identifying the user stored in a SMX chip 151 incorporated in the IC card 150. The module 130 incorporates a SMX chip 131 therein, and the SMX chip 131 stores the service ID for identifying the module therein. The terminal 120 reads the service ID stored in the SMX chip 131. The terminal 120 may read the service ID stored in the SMX chip 123 incorporated therein. The terminal 120 transmits the service IDs to a physical authentication layer 111 thereby to make an authentication request for the service ID. In the present example, two service IDs including the service ID stored in the SMX chip 131 and the service ID stored in the SMX chip 151 are assumed to be transmitted to the physical authentication layer 111.

The PaaS layer 110 includes an integrated database 117 (which will be denoted as integrated DB 117 below) and an authentication database 118 (which will be denoted authentication DB 118 below). The integrated DB 117 corresponds to the management information storage means 17 according to the first exemplary embodiment. The authentication DB 118 corresponds to the authentication information storage means 15 according to the first exemplary embodiment. The PaaS layer 110 can be divided into a virtual layer 115 and a real layer 116.

The real layer 116 contains the physical authentication layer 111. The physical authentication layer 111 corresponds to the service ID authentication means 11 according to the first exemplary embodiment. The virtual layer 115 contains an ID handling layer 112, an ID authentication layer 113 and an authentication service layer 114. The ID handling layer 112 corresponds to the use service judgment means 12 according to the first exemplary embodiment. The ID authentication layer 113 corresponds to the authentication information management means 13 according to the first exemplary embodiment. The authentication service layer 114 corresponds to the use right judgment means 14 according to the first exemplary embodiment.

In the present example, two services are assumed to be provided. One is DaaS (Desktop-as-a-Service) service and the other is a service in which a print instruction and an output instruction are made at different timings (which will be denoted as printing service below). For both services, it is assumed that the same service is used in a plurality of tenants (or multi-tenants). A combination of physical ID of the IC card and service ID stored in the IC card is assumed as key ID. The service ID of the IC card is a user's employee number encrypted and stored in SMX, for example. The physical ID is UID of Mifare of the SMX chip, for example. An exemplary physical ID may be IDm of Felica (trademark), for example. The physical ID is burned on the chip on manufacture, and is given to each chip in a non-rewritable state.

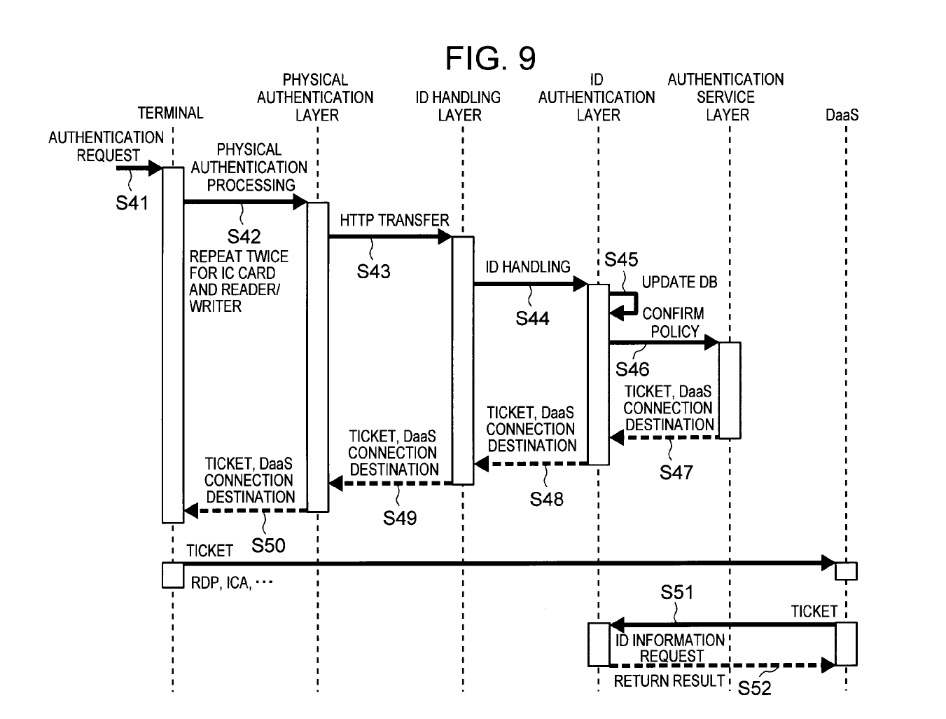

At first, a case in which the user utilizes the DaaS service will be described. FIG. 9 is a sequence diagram illustrating exemplary operations of the authentication system when the user utilizes the DaaS service. The user utilizing the cloud system puts the IC card 150 over a reader/writer (herein, the module 130) thereby to make an authentication request (step S41). Specifically, an authentication request is made when the user logs in DaaS.

An authentication request is made to the physical authentication layer 111 when the service ID of the IC card 150 is read. Herein, two service IDs of the IC card 150 and the reader/writer are to be authenticated. The service ID of the reader/writer is a reader/writer ID of a vender, which is encrypted and stored in SMX, for example. The physical ID is IDm of SMX, for example. The terminal 120 repeatedly (herein, twice) makes as many physical authentication requests as service IDs to the physical authentication layer 111 (step S42).

The physical authentication layer 111 authenticates each service ID and collectively transmits the service IDs, the physical ID and the app CD which are requested to authenticate at one time to the ID handling layer 112. Herein, the physical authentication layer 111 transfers a validity judgment result (authentication result) to the higher-ordered ID handling layer 112 by use of HTTP (step S43).

The ID handling layer 112 performs ID handling for distributing the received service IDs to each tenant based on the app CD and the key physical ID transferred from the physical authentication layer 111. Specifically, for different tenants, the ID handling layer 112 handles the service ID to the server of the ID authentication layer 113 identified by different URL, respectively (step S44).

The ID authentication layer 113 updates the contents of the authentication DB 118 by use of the service ID received from the ID handling layer 112 (step S45). The ID authentication layer 113 manages authentication data per combination of app CD and key ID. Herein, the key ID is set per app CD. Herein, the ID authentication layer 113 manages authentication data per combination of app CD (specifically, app CD for identifying the DaaS service) and employee ID card number.

The ID authentication layer 113 deletes the corresponding old service IDs on every authentication, and manages only the latest service ID. The ID authentication layer 113 may delete the service ID stored in the authentication DB 118 at an explicit moment by the terminal 120. The explicit moment may be a timing when the log-out button is pressed in the application of the terminal 120 or a timing when the employee ID card is released from the reader/writer for a service usable only while the employee ID card is being read, for example. The ID authentication layer 113 may delete the service ID after a certain period of time elapses (or at a timing of timeout).

The ID authentication layer 113 requests the authentication service layer 114 to authenticate the user by policy confirmation (step S46). The authentication service layer 114 judges whether the user can use the DaaS service based on the policy. When judging that the DaaS service is available, the authentication service layer 114 issues a ticket for utilizing the DaaS service, and transmits the ticket and the information on the connection destination for utilizing the DaaS service to the terminal 120 via the ID authentication layer 113, the ID handling layer 112 and the physical authentication layer 111 (steps S47 to S50).

In the present example, the user is authenticated by use of the ticket issued by the authentication service layer 114. Thus, security can be further enhanced than when the log-in ID is transmitted as it is, for example.

Subsequently, when receiving the ticket and the information indicating the connection destination of the DaaS service, the terminal 120 utilizes the cooperative service by use of a protocol such as RDP (Remote Desktop Protocol) or ICA (Independent Computing Architecture).

Thereafter, when the ticket and an ID information request are asynchronously transmitted from the service provider present in the SaaS layer 160 to the PaaS layer 110 (step S51), the ID authentication layer 113 returns the service ID to the service provider in response to the request (step S52). The information returned by the ID authentication layer 113 is not limited to the service ID. The ID authentication layer 113 may return information such as log-in ID used for the service to the service provider based on the received ticket, for example.

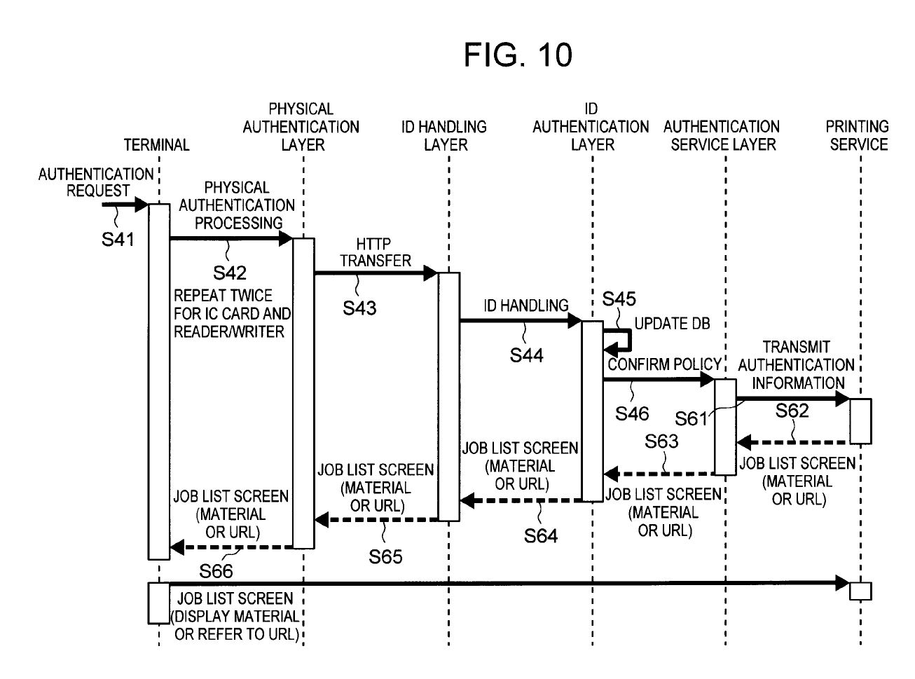

A case in which the user utilizes the printing service will be described below. FIG. 10 is a sequence diagram illustrating exemplary operations of the authentication system when the user utilizes the printing service. The user utilizing the cloud system puts the IC card 150 over a reader/writer (herein, the module 130) thereby to make an authentication request (step S41). Specifically, an authentication request is made when the user prints out print data. Subsequently, the contents of steps S42 to S46 until the authentication service layer 114 authenticates the user after an authentication request is made to the physical authentication layer 111 are similar to the contents illustrated in FIG. 9.

The authentication service layer 114 judges whether the printing service is available to the user based on the policy. When judging that the printing service is available, the authentication service layer 114 transmits the information used for authentication to the service provider (step S61). The service provider transmits the job list screen or job screen display destination URL executable by the user based on the authentication information to the terminal 120 via the authentication service layer 114, the ID authentication layer 113, the ID handling layer 112 and the physical authentication layer 111 (steps S62 to S66). Subsequently, the terminal 120 makes a print instruction with reference to the job list screen or the screen displayed at the display destination URL.

The operations when the user utilizes the DaaS service or printing service has been described above. In the above exemplary operations, the ID authentication layer 113 receiving the service ID from the ID handling layer 112 performs authentication based on the service ID. After receiving the service ID from the ID handling layer 112, the ID authentication layer 113 may request information necessary for authenticating the user to the terminal 120 again.

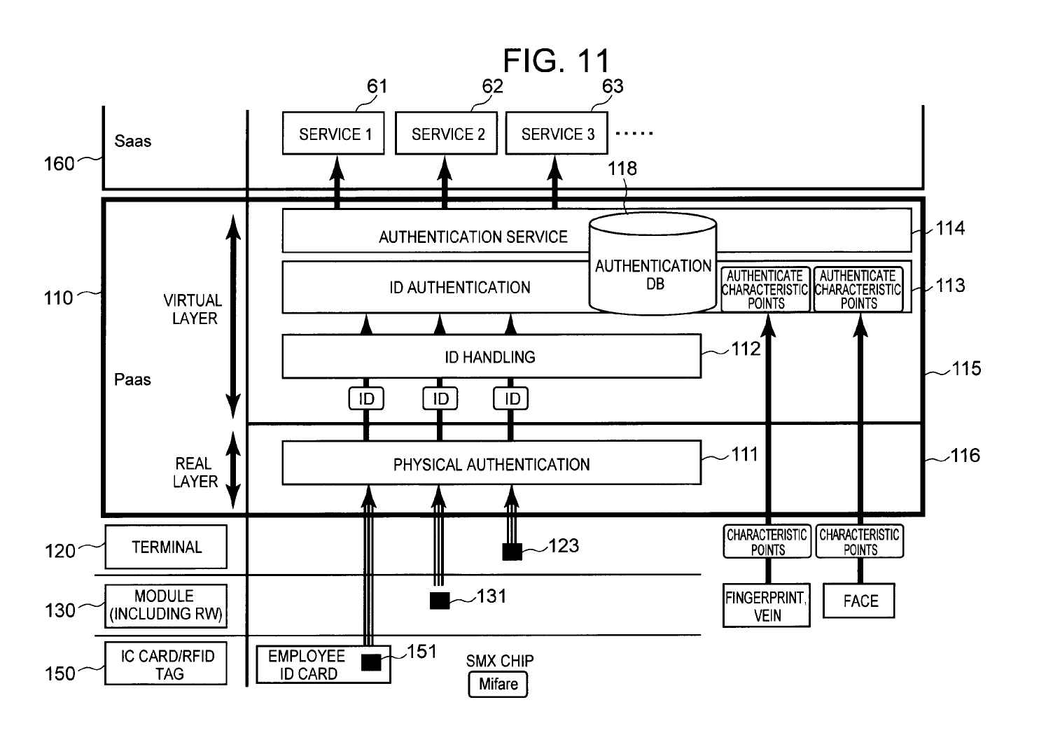

FIG. 11 is an explanatory diagram illustrating exemplary operations for transmitting information from the terminal to the ID authentication layer. When receiving a request of transmitting information necessary for the user from the ID authentication layer 113, the terminal acquires characteristic points of each item of information by use of a module for reading a fingerprint or vein or a module for extracting a face image. Then, the terminal transmits the information on the characteristic points to the ID authentication layer 113. When receiving the information on the characteristic points, the ID authentication layer 113 stores the received information and the previously-received service ID in the authentication DB 118 in association with the key ID. The information is stored in the authentication DB 118 so that the authentication service layer 114 can perform more dynamical authentication.

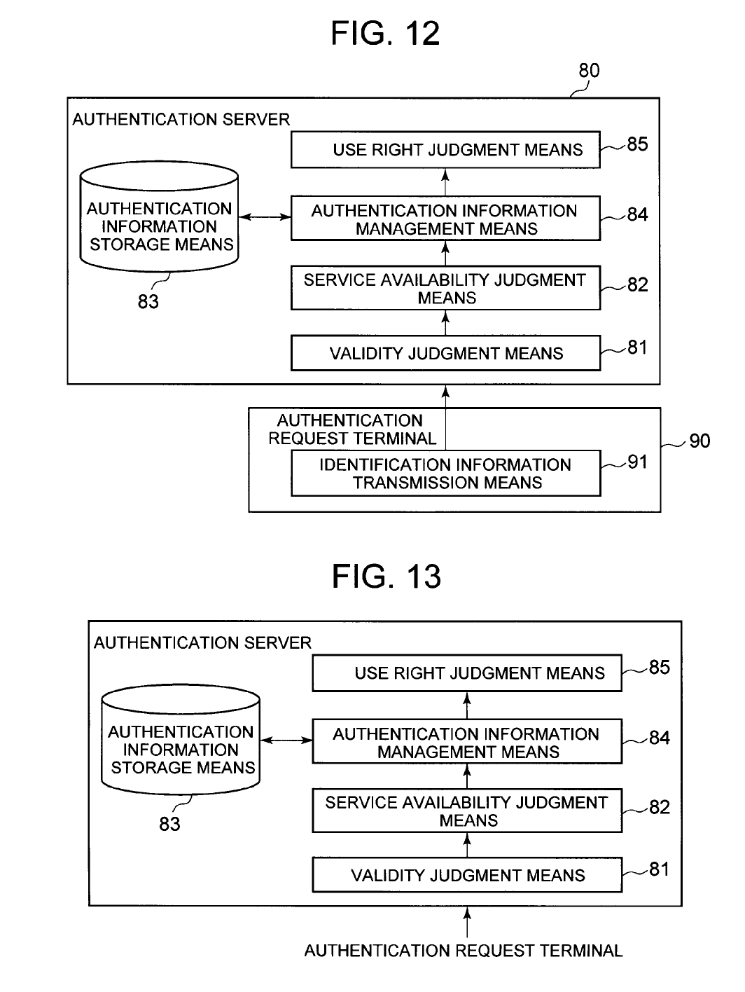

An exemplary minimum structure of the present invention will be described below. FIG. 12 is a block diagram illustrating an exemplary minimum structure of the authentication system according to the present invention. The authentication system according to the present invention includes an authentication server 80 (such as the authentication server 10) for authenticating a user utilizing a service, and an authentication request terminal 90 (such as the terminal 20) for making a service authentication request to the authentication server 80.

The authentication request terminal 90 includes an identification information transmission means 91 (such as the identification information extraction means 21) for transmitting, to the authentication server 80, a physical ID as identification information capable of uniquely identifying a medium (such as the IC card 50) or device (such as the in-terminal device 30, the external connection device 40 or the terminal 20) used for authenticating a user utilizing a service, and a service ID as identification information defined per type of each medium or device.

The authentication server 80 includes a validity judgment means 81 (such as the service ID authentication means 11) for judging validity of each received service ID, a service availability judgment means 82 (such as the use service judgment means 12) for judging availability of a service utilizing a medium or device identified by a physical ID based on the received physical ID, an authentication information management means 84 (such as the authentication information management means 13) for, when it is judged that a service utilizing the medium or device is available, storing at least a service ID and a judgment result of the service ID by the validity judgment means 81 in an authentication information storage means 83 (such as the authentication information storage means 15) in association with a key ID with a combination of one or more service IDs capable of identifying one authentication request by the user among received service IDs as the key ID, and a use right judgment means 85 (such as the use right judgment means 14) for judging a use right of a service utilized by the user from a service ID and a judgment result of the service ID in association with a key ID stored in the authentication information storage means 83 based on a policy defining a service available range depending on at least the combination of service IDs.

An identification information transmission means 91 in the authentication request terminal 90 transmits, to the authentication server 80, a physical ID of a previously-defined medium or device among one or more mediums or devices used for authentication, and one or more previously-defined service IDs of the medium or device used for authentication.

With the structure, high-level authentication control can be dynamically performed depending on an environment in which the user utilizes a service.

The identification information transmission means 91 in the authentication request terminal 90 may transmit, to the authentication server 80, a combination of service IDs and a physical ID corresponding to the services which the user requests to authenticate among the combinations of one or more service IDs and the physical IDs previously defined per service in association with an application code (app CD) as an identifier for identifying the service. The authentication information management means 84 in the authentication server 80 may store at least a service ID and a judgment result of the service ID by the validity judgment means 81 in the authentication information storage means 83 in association with a key ID and an application code. The use right judgment means 85 in the authentication server 80 may judge user's use right for a service identified by an application code.

With the structure, even when a plurality of user available services are present, the authentication processing can be performed on each service, respectively.

The authentication request terminal 90 may include a selected service acceptance means (such as the selected service acceptance means 24) for accepting selection of a service utilized by the user. The identification information transmission means 91 in the authentication request terminal 90 may transmit, to the authentication server 80, an application code for identifying a service accepted by the selected service acceptance means in association with a combination of one or more service IDs previously defined for the service and a physical ID.

The authentication request terminal 90 may include a service ID read means (such as the identification information extraction means 21) for reading a service ID encrypted and stored in a storage means (such as the identification information storage means or authenticated LSI) having tamper resistance provided in each medium or device. The identification information transmission means 91 in the authentication request terminal 90 may transmit the encrypted service ID to the authentication server 80. The validity judgment means 81 in the authentication server 80 may decrypt each encrypted service ID thereby to judge validity of the service ID.

The authentication information management means 84 in the authentication server 80 may store information indicating a network or time where or when the user makes a service authentication request (such as network identification information, time/date when the user makes an authentication request, or time/date when the authentication processing is performed) in association with a key ID in the authentication information storage means 83. The use right judgment means 85 in the authentication server 80 may judge a use right of a service to be utilized by the user from the service ID corresponding to the key ID stored in the authentication information storage means 83, the judgment result of the service ID, and the information indicating a network or time based on a policy defining a service available range depending on at least the information indicating a network or time and a combination of service IDs.

The identification information transmission means 91 in the authentication request terminal 90 may transmit user identification information (such as characteristic points of a fingerprint or vein, or characteristic points of a face image) specified by human physical characteristics or behavior characteristics to the authentication server 80. The authentication information management means 84 in the authentication server 80 may store the user identification information in the authentication information storage means 83 in association with the key ID. The use right judgment means 85 in the authentication server 80 may judge a use right of a service to be utilized by the user based on the user identification information.

The authentication information management means 84 in the authentication server 80 may delete the information stored in the authentication information storage means 83 after a certain period of time elapses.

When receiving an authentication request identified by the same key ID previously stored in the authentication information storage means 83, the authentication information management means 84 in the authentication server 80 may update the information corresponding to the key ID with the information contained in the authentication request.

FIG. 13 is a block diagram illustrating an exemplary minimum structure of the authentication server according to the present invention. The authentication server according to the present invention includes the validity judgment means 81, the service availability judgment means 82, the authentication information management means 84 for storing at least a service ID and a judgment result of the service ID in the authentication information storage means 83 in association with a key ID, and the use right judgment means 85. The contents of the validity judgment means 81, the service availability judgment means 82, the authentication information storage means 83, the authentication information management means 84 and the use right judgment means 85 are the same as the constituents provided in the authentication server 80 illustrated in FIG. 12. Also with the structure, high-level authentication control can be dynamically performed depending on an environment in which the user utilizes a service.

The present invention has been described above with reference to the exemplary embodiments and the example, but the present invention is not limited to the exemplary embodiments and the example. The structure or details of the present invention can be variously changed within the scope of the present invention understood by those skilled in the art.

The present application claims the priority based on Japanese Patent No. 2011-204438 filed on Sep. 20, 2011, the entirety of which disclosure is incorporated herein by reference.

### INDUSTRIAL APPLICABILITY

The present invention is suitably applied to an authentication system for authenticating a user utilizing a service.

### REFERENCE SIGNS LIST

10 Authentication server
11,11a Service ID authentication means
12,12a Use service judgment means
13,13a Authentication information management means
14,14a Use right judgment means
15,15a Authentication information storage means
16 Policy storage means
17 Management information storage means
20 Terminal
21,21a Identification information extraction means
22,22a Authentication request instruction means
23,31,41,51 Identification information storage means
30 In-terminal device
40 External connection device
50 IC card
100 Communication network

1. An authentication system comprising:
an authentication server for authenticating a user utilizing a service; and
an authentication request terminal for making a service authentication request to the authentication server,
wherein the authentication request terminal comprises an identification information transmission unit for transmitting a physical ID as identification information capable of uniquely identifying a medium or device used for authenticating a user utilizing a service, and a service ID as identification information defined per type of the medium or device to the authentication server,
the authentication server comprise:
a validity judgment unit for judging validity of each received service ID;
a service availability judgment unit for judging availability of a service utilizing a medium or device identified by a physical ID based on the received physical ID;
an authentication information management unit for, when it is judged that a service utilizing the medium or device is available, storing at least a service ID and a judgment result of the service ID by the validity judgment unit in association with a key ID in an authentication information storage unit with a combination of one or more service IDs capable of identifying one authentication request made by the user among received service IDs as the key ID; and
a use right judgment unit for judging a use right of a service to be utilized by the user from a service ID and a judgment result of the service ID in association with a key ID stored in the authentication information storage unit based on a policy defining a service available range depending on at least the combination of service IDs, and
the identification information transmission unit in the authentication request terminal transmits a physical ID of a previously-defined medium or device among one or more mediums or devices used for authentication, and one or more previously-defined service IDs in the medium or device used for authentication to the authentication server.

2. The authentication system according to claim 1,
wherein the identification information transmission unit in the authentication request terminal transmits, to the authentication server, a combination of service IDs and a physical ID corresponding to a service which the user requests to authenticate among combinations of one or more service IDs and physical IDs previously defined per service in association with an application code as an identifier for identifying the service,
the authentication information management unit in the authentication server stores at least a service ID and a judgment result of the service ID by the validity judgment unit in the authentication information storage unit in association with a key ID and the application code, and
the use right judgment unit in the authentication server judges user's use right for a service identified by an application code.

3. The authentication system according to claim 2,
wherein the authentication request terminal comprises a selected service acceptance unit for accepting selection of a service to be utilized by the user, and
the identification information transmission unit in the authentication request terminal transmits, to the authentication server, an application code for identifying a service accepted by the selected service acceptance unit in association with a combination of one or more service IDs and a physical ID previously defined for the service.

4. The authentication system according to claim 1,
wherein the authentication request terminal comprises a service ID read unit for reading a service ID encrypted and stored in a storage unit having tamper resistance provided in each medium or each device,
the identification information transmission unit in the authentication request terminal transmits an encrypted service ID to the authentication server, and
the validity judgment unit in the authentication server decrypts each encrypted service ID thereby to judge validity of the service ID.

5. The authentication system according to claim 1,
wherein the authentication information management unit in the authentication server stores information indicating a network or time where or when the user makes a service authentication request in the authentication information storage unit in association with a key ID, and
the use right judgment unit in the authentication server judges a use right of a service to be utilized by the user from a service ID corresponding to a key ID stored in the authentication information storage unit, a judgment result of the service ID, and the information indicating a network or time based on a policy defining a service available range depending on at least the information indicating a network or time and a combination of service IDs.

6. The authentication system according to claim 1,
wherein the identification information transmission unit in the authentication request terminal transmits user identification information specified by human physical characteristics or behavior characteristics to the authentication server,
the authentication information management unit in the authentication server stores the user identification information in the authentication information storage unit in association with a key ID, and
the use right judgment unit in the authentication server judges a use right of a service to be utilized by the user based on the user identification information.

7. The authentication system according to claim 1,
wherein the authentication information management unit in the authentication server deletes information stored in the authentication information storage unit after a certain period of time elapses.

8. The authentication system according to claim 1,
wherein when receiving an authentication request identified by the same key ID previously stored in the authentication information storage unit, the authentication information management unit in the authentication server updates information corresponding to the key ID with information contained in the authentication request.

9. An authentication server comprising:
a validity judgment unit for judging validity of each service ID when receiving a physical ID as identification information capable of uniquely identifying a medium or device used for authenticating a user utilizing a service and a service ID as identification information defined per type of the medium or device from an authentication request terminal for making an authentication request for the service;
a service availability judgment unit for judging availability of a service utilizing a medium or device identified by a physical ID based on the received physical ID;
an authentication information management unit for, when it is judged that a service utilizing the medium or device is available, storing at least a service ID and a judgment result of the service ID by the validity judgment unit in an authentication information storage unit in association with a key ID with a combination of one or more service IDs capable of identifying one authentication request made by the user among received service IDs as the key ID; and
a use right judgment unit for judging a use right of a service to be utilized by the user from a service ID and a judgment result of the service ID in association with a key ID stored in the authentication information storage unit based on a policy defining a service available range depending on at least the combination of service IDs.

10. The authentication server according to claim 9,
wherein when receiving a combination of service IDs and a physical ID corresponding to a service which the user requests to authenticate from the authentication request terminal together with an application code as an identifier for identifying the service, the authentication information management unit stores at least a service ID and a judgment result of the service ID by the validity judgment unit in the authentication information storage unit in association with a key ID and the application code, and
the use right judgment unit judges user's use right for a service identified by an application code.

11. An authentication method, wherein an authentication request terminal for making a service authentication request to an authentication server for authenticating a user utilizing a service transmits, to the authentication server, a physical ID as identification information capable of uniquely identifying a medium or device used for authenticating a user utilizing the service and a service ID as identification information defined per type of the medium or device,
the authentication server judges validity of each received service ID,
the authentication server judges availability of a service utilizing a medium or device identified by a physical ID based on the received physical ID,
when judging that a service utilizing the medium or device is available, the authentication server stores at least a service ID and a validity judgment result of the service ID in an authentication information storage unit in association with a key ID with a combination of one or more service IDs capable of identifying one authentication request made by the user among received service IDs as the key ID,
the authentication server judges a use right of a service to be utilized by the user from a service ID and a judgment result of the service ID in association with a key ID stored in the authentication information storage unit based on a policy defining a service available range depending on at least the combination of service IDs, and
when transmitting the physical ID and the service ID, the authentication request terminal transmits, to the authentication server, a physical ID of a previously-defined medium or device among one or more mediums or devices used for authentication, and one or more previously-defined service IDs in the medium or device used for authentication.

12. The authentication method according to claim 11,
wherein the authentication request terminal transmits, to the authentication server, a combination of service IDs and a physical ID corresponding to a service which the user requests to authenticate among combinations of one or more service IDs and physical IDs previously defined per service in association with an application code as an identifier for identifying the service,
the authentication server stores at least a service ID and a validity judgment result of the service ID in the authentication information storage unit in association with a key ID and the application code, and
the authentication server judges user's use right of a service identified by an application code.

13. A non-transitory computer readable information recording medium storing an authentication program that, when executed by a processor, performs a method:
judging validity of each service ID when receiving a physical ID as identification information capable of uniquely identifying a medium or device used for authenticating a user utilizing a service and a service ID as identification information defined per type of the medium or device from an authentication request terminal for making an authentication request for the service;
judging availability of a service utilizing a medium or device identified by a physical ID based on the received physical ID;
when it is judged that a service utilizing the medium or device is available, storing at least a service ID and a validity judgment result of the service ID in an authentication information storage unit in association with a key ID with a combination of one or more service IDs capable of identifying one authentication request made by the user among received service IDs as the key ID; and
judging a use right of a service to be utilized by the user from a service ID and a judgment result of the service ID in association with a key ID stored in the authentication information storage unit based on a policy defining a service available range depending on at least the combination of service IDs.

14. The non-transitory computer readable information recording medium according to claim 13, further comprising:
storing at least a service ID and a validity judgment result of the service ID in the authentication information storage unit in association with a key ID and an application code when receiving a combination of service IDs and a physical ID corresponding to a service which the user requests to authenticate from the authentication request terminal together with the application code as an identifier for identifying the service; and
judging user's use right for a service identified by an application code.

15. The authentication system according to claim 2,
wherein the authentication request terminal comprises a service ID read unit for reading a service ID encrypted and stored in a storage unit having tamper resistance provided in each medium or each device,
the identification information transmission unit in the authentication request terminal transmits an encrypted service ID to the authentication server, and
the validity judgment unit in the authentication server decrypts each encrypted service ID thereby to judge validity of the service ID.

16. The authentication system according to claim 3,
wherein the authentication request terminal comprises a service ID read unit for reading a service ID encrypted and stored in a storage unit having tamper resistance provided in each medium or each device,
the identification information transmission unit in the authentication request terminal transmits an encrypted service ID to the authentication server, and
the validity judgment unit in the authentication server decrypts each encrypted service ID thereby to judge validity of the service ID.

17. The authentication system according to claim 2,
wherein the authentication information management unit in the authentication server stores information indicating a network or time where or when the user makes a service authentication request in the authentication information storage unit in association with a key ID, and
the use right judgment unit in the authentication server judges a use right of a service to be utilized by the user from a service ID corresponding to a key ID stored in the authentication information storage unit, a judgment result of the service ID, and the information indicating a network or time based on a policy defining a service available range depending on at least the information indicating a network or time and a combination of service IDs.

18. The authentication system according to claim 3,
wherein the authentication information management unit in the authentication server stores information indicating a network or time where or when the user makes a service authentication request in the authentication information storage unit in association with a key ID, and
the use right judgment unit in the authentication server judges a use right of a service to be utilized by the user from a service ID corresponding to a key ID stored in the authentication information storage unit, a judgment result of the service ID, and the information indicating a network or time based on a policy defining a service available range depending on at least the information indicating a network or time and a combination of service IDs.

19. The authentication system according to claim 4,
wherein the authentication information management unit in the authentication server stores information indicating a network or time where or when the user makes a service authentication request in the authentication information storage unit in association with a key ID, and
the use right judgment unit in the authentication server judges a use right of a service to be utilized by the user from a service ID corresponding to a key ID stored in the authentication information storage unit, a judgment result of the service ID, and the information indicating a network or time based on a policy defining a service available range depending on at least the information indicating a network or time and a combination of service IDs.

20. The authentication system according to claim 2,
wherein the identification information transmission unit in the authentication request terminal transmits user identification information specified by human physical characteristics or behavior characteristics to the authentication server,
the authentication information management unit in the authentication server stores the user identification information in the authentication information storage unit in association with a key ID, and
the use right judgment unit in the authentication server judges a use right of a service to be utilized by the user based on the user identification information.
